(19) United States
(12) Patent Application Publication
(10) Pub. No.: US 2002/0055858 A1
(43) Pub. Date: May 9, 2002

(54) Method of financing payments to providers of medical services

(76) Inventor: Stephen W. Jackson, Houston, TX (US)

Correspondence Address: Todd Mattingly, Haynes and Boone, LLP, Suite 4300, 1000 Louisiana Street, Houston, TX, 77002-5012, US

(21) Appl. No.: 09/867,126

(22) Filed: May 29, 2001

Related U.S. Application Data
(60) Provisional application No. 60/207,873, filed on May 30, 2000.

(51) Int. Cl. G06F 17/60

(52) U.S. Cl. 705/3

(57) ABSTRACT

A method of providing medical services. An auxiliary provider of medical services contracts with a payor of medical services to provide medical services to patients covered by the payor in exchange for a payment of money. The medical services are denominated in medical relative value units. The auxiliary provider of medical services contracts with a primary provider of medical services to provide a block of medical relative value units to the patients in exchange for a payment of money. The auxiliary provider of medical services and the primary provider of medical services establish corresponding accounts receivable and payable, respectively, that are maintained and updated as the primary provider of medical services delivers medical relative value units to the covered patients.

### CROSS REFERENCE TO RELATED APPLICATIONS

This application claims the benefit of the filing date of U.S. provisional patent application serial No. 60/207,873, filed on May 30, 2000, the disclosure of which is incorporated herein by reference.

### BACKGROUND

This invention relates generally to providing medical services to patients, and in particular to financing payments to providers of medical services to patients.

In the modern health care industry, there currently exist the following groups of entities: (1) Payors; (2) Providers; and (3) Auxiliary Service Providers.

The Payors may be, for example, insurance companies, third-party administrators, self-insured employers, government agencies or any other party who pays for health care services on behalf of patient beneficiaries.

The Providers, or sometimes Service Providers, may be, for example, physicians, hospitals, skilled nursing facilities, outpatient diagnostic or surgical facilities or any other party who delivers medical care to patient beneficiaries.

The Auxiliary Service Providers assist the Payors in managing the various medical specialties such as, for example, radiology, orthopedics, cardiology or the like. These Auxiliary Service Providers are experts in their particular medical specialty and typically are given the responsibility for delivering care to the Payor's covered patient members in a defined geographic area. Thus, the Auxiliary Service Providers provide an interface between the Providers and the Payors.

The modern health care industry also uses a currency referred to as medical relative value units (RVUs). All medical procedures have a medical RVU value assigned to them. For example, a flu shot may be worth 1 medical RVU while brain surgery may be worth 10,000 medical RVUs. The assigned medical RVU value may then be multiplied by a Conversion Factor to arrive at the dollar value of the particular medical procedure. The number of medical RVUs allocable to a given medical procedure are determined by the Health Care Finance Agency (HCFA) on an annual basis and changes are published. A Conversion Factor is also established and maintained by the HCFA, and the Conversion Factor represents the dollar value of one medical RVU. The Conversion Factor is modified by the HCFA annually. For the year 2000, the Conversion Factor is $36,6137. For any given medical procedure, the product of the Conversion Factor and the number of medical RVUs allocable to the given medical procedure is also commonly referred to as the Medicare Allowable since it places a cap upon the amount that Medicare will pay for the given medical procedure.

Conventionally, there are generally two ways in which Providers are compensated by Payors: (a) Capitation; and (b) Fee-For-Service.

In a Capitation system, the Payor pays a sum certain per covered member to a Provider or Auxiliary Service Provider every month. This charge is typically referred to as the per member per month charge (PMPM). For example, the Payor may agree to pay $7 PMPM to auxiliary provider for all, or only certain, radiology services delivered to all of the Payor's covered members in Austin, Tex. If the Payor has 50,000 such members, the Payor may pay the Auxiliary Service Provider a lump sum of $350,000 per month. In exchange, the Auxiliary Service Provider agrees to provide all of the agreed upon radiology services needed by all 50,000 of the Payors' members each month. The Auxiliary Service Provider will also typically deduct an Administrative Services Fee from the lump sum with the remainder typically referred to as the Monthly Capitation Pool. Thus, the Monthly Capitation Pool is the sum of money available to pay the Provider of medical services.

On a daily basis, the Providers then submit claims to the Auxiliary Service Provider that describe the medical procedure(s) provided by the Providers to the patients covered by the Auxiliary Service Provider. The description of the medical procedure(s) provided typically include a Current Physician Terminology (CPT) five-digit medical procedure code plus, in many instances, a series of one or more modifiers. The version of CPT currently in use is the fourth edition and is commonly referenced as CPT-4. Each CPT-4 medical procedure code is assigned a value denominated in medical RVU's.

The Monthly Capitation Pool is then distributed by the Auxiliary Service Provider to the Providers based upon the number of medical RVUs provided by the Providers to the patients covered by the Auxiliary Service Provider during the corresponding month in a process commonly referred to as Pool Settlement.

In a Fee-For-Service system, the Payor, the Auxiliary Provider and the Provider agree that a certain procedure is worth a certain dollar amount to each party. The Payor's covered members receive services at Provider's facility, the Provider submits a claim form to the Auxiliary Service Provider; and the Auxiliary Service Provider in turn forwards the claim form to the Payor for payment. The Payor returns payment to the Auxiliary Service Provider who takes a nominal administrative fee and the balance of the payment is remitted to the Provider.

The conventional methods of financing payments to providers of medical services do not provide certainty with respect to the timing or amount of payment to either the Payor or the Provider.

Furthermore, the Payors and the Providers also have difficulty providing the medical services, verifying that the provided medical services are covered by the Payor, and then paying the Provider in a timely and accurate fashion. From the Payor's perspective, certainty is desired with respect to the amount of medical expense to be incurred for a given population. The Payor may accomplish some degree of certainty by entering into a Capitation system with the Provider or the Auxiliary Service Provider, but this merely shifts the uncertainty from the Provider to the Auxiliary Service Provider. The party so engaged must then accept the risk of the uncertainty and either live with it or seek another way of getting the desired certainty.

From the perspective of the Provider, the timing and predictability of payments to be received for services rendered is still a problem. For example, when the Provider performs a medical service or procedure, the Provider will typically have to submit a claim form to the Payor. Although the claim forms may be standardized, claim forms are very complex and completing the claim forms, generally, is relegated to clerical staff with minimal training and/or expertise. Further, the typical initial filing of a claim form by the Provider will be submitted with the Provider's customary charge for the service or procedure performed, causing a delay later on. Other minor errors which might be overlooked by human claims processors are not overlooked by the Payor's computers and claims are commonly denied. All of these errors will require that the Provider resubmit a corrected form. Once properly resubmitted, the Provider might find that in the interim their billed charges have been reduced by the patient's deductible, co-payment, coinsurance or other amounts with the result that the amount actually received by the Provider bears no relation to the billed charges. In short, the Provider has no reasonable expectation of when they will be paid or how much they will be paid and frequently must wait four to six months to receive even a 30%, 40% or 50% portion of their billed charges.

Furthermore, conventionally, the Auxiliary Service Provider may also accept the capitation payment from the Payor, such as, for example, an insurance company, deduct an administrative services fee, e.g. 15%, and then pay the remaining amount to the Provider for services rendered to the covered patients. Guaranteed minimums may be required by the Provider in order to induce the Provider to join a network serviced by the Auxiliary Service Provider. The nature of these guarantees are such that the sum of all of the Provider's services to covered members will result in a Pool Settlement of no less than 80%, 90% or 100% of the Medicare Allowable amount. Inherent in the Providers' calculation of the minimum they are willing to accept is the perception of risk that they will provide services to covered members for a month or two and then find that the Auxiliary Service Provider has disappeared or otherwise become insolvent, leaving the Providers with a large uncollectible receivable.

The present invention is directed to overcoming one or more of the limitations of existing methods of providing medical services.

### SUMMARY

According to one aspect of the present invention, a method of financing payments to providers of medical services to patients is provided that includes the patients making payments to a payor in exchange for the payor's promise to provide medical RVUs to the patients, the payor making payments to an auxiliary service provider in exchange for the auxiliary service provider's promise to provide medical RVUs to the patients, and the auxiliary service provider making a payment to a primary service provider in exchange for the primary service provider's promise to provide a block of medical RVUs to the patients.

According to another aspect of the present invention, a method of financing payments to providers of medical services to patients is provided that includes the patients making payments to one or more payors in exchange for the payors' promises to provide medical RVUs to the patients, the payors making payments to one or more auxiliary service providers in exchange for the auxiliary service providers' promises to provide medical RVUs to the patients, the auxiliary service providers bidding on blocks of medical RVUs offered for sale by one or more primary service providers in a medical RVU trading system, and the auxiliary service providers contracting with one or more of the primary service providers using the medical RVU trading system.

According to another aspect of the present invention, a method of financing payments to providers of medical services to patients is provided that includes the patients making a payment to a primary service provider in exchange for the primary service provider's promise to provide a block of medical RVUs to the patients.

According to another aspect of the present invention, a method of financing payments to providers of medical services to patients is provided that includes the patients bidding on blocks of medical RVUs offered for sale by one or more primary service providers in a medical RVU trading system, and the patients contracting with one or more of the primary service providers using the medical RVU trading system.

The present embodiments of the invention provide a method for financing payments to providers of medical services to patients that reduces the overall cost of providing medical services to patients. Furthermore, the method also provides predictability with regard to the payment for medical services as well as the use of the available capacity. In this manner, the present embodiments of the invention provides a more cost efficient and economical method of financing payments to providers of medical services.

### BRIEF DESCRIPTION OF THE DRAWINGS

FIG. 1 is a schematic illustration an embodiment of a system for providing medical services.

FIGS. 2a and 2b are flow chart illustrations of an embodiment of the operation of the system of FIG. 1.

FIG. 3 is a schematic illustration of an exemplary embodiment of a medical RVU account payable for use in the system of FIG. 1.

FIG. 4 is a schematic illustration of an exemplary embodiment of a medical RVU account receivable for use in the system of FIG. 1.

FIG. 5 is a schematic illustration of an exemplary implementation of the system of FIG. 1.

FIG. 6 is a schematic illustration of an exemplary implementation of the system of FIG. 1.

FIG. 7 is a schematic illustration of an alternative embodiment of the system of FIG. 1.

FIG. 8 is a schematic illustration of an alternative embodiment of a system for providing medical services.

FIG. 9 is a flow chart illustration of an embodiment of the operation of the system of FIG. 8.

FIG. 10 is a schematic illustration of an exemplary embodiment of a medical RVU account payable for use in the system of FIG. 8.

FIG. 11 is a schematic illustration of an exemplary embodiment of a medical RVU account receivable for use in the system of FIG. 8.

### DESCRIPTION OF THE PREFERRED EMBODIMENTS

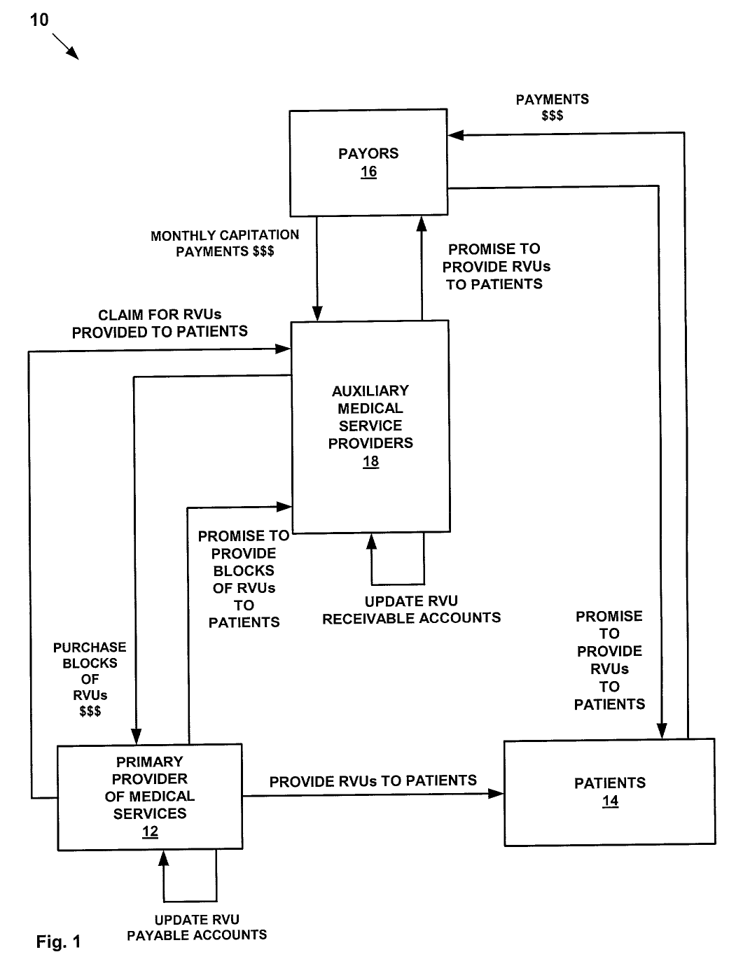

Referring to FIG. 1, the reference numeral 10 refers, in general, to a system for providing medical services that includes one or more primary service providers of medical services 12, one or more patients 14, one or more payors of medical services 16, and one or more auxiliary medical service providers 18.

The primary service provider of medical services 12 may, for example, include physicians, hospitals, skilled nursing facilities, outpatient diagnostic or surgical facilities or any other party who delivers medical care to patients. The payors of medical services 16 may, for example, be insurance companies, third-party administrators, self-insured employers, government agencies or any other party who pays for health care services on behalf of the patients 14.

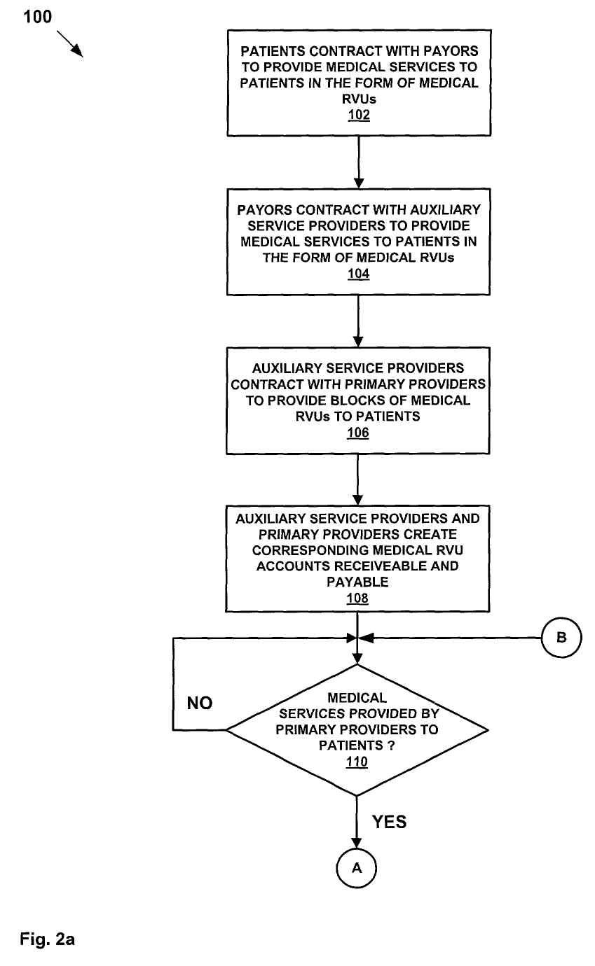

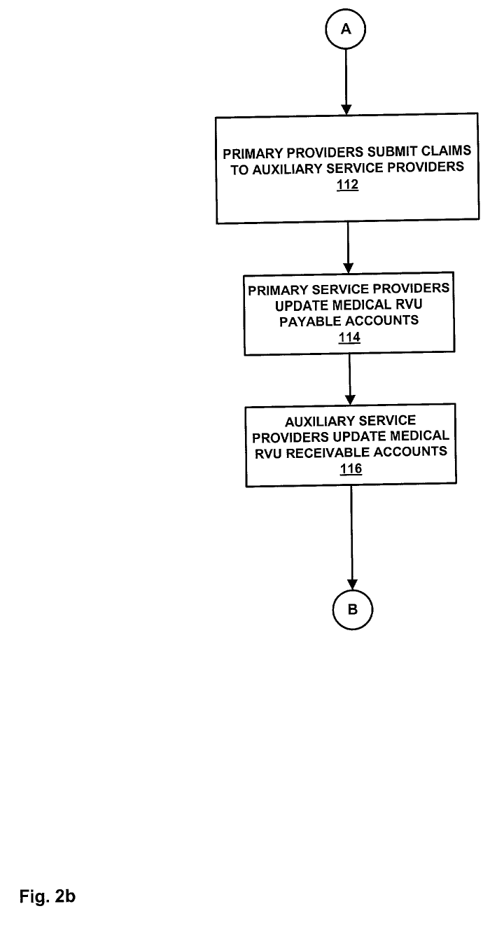

In an exemplary embodiment, during the operation of the system 10, as illustrated in FIGS. 1, 2a, and 2b, the system 10 may implement a method 100 of providing medical services in which the patients 14 may contract with the payors 16 by sending payments to the payors in return for the payors' promises to provide the patients with medical services in the form of medical RVUs in the future in step 102. In an exemplary embodiment, the payments made by the patients 14 to the payors 16 may be, for example, monthly health insurance premiums.

The payors 16 may then contract with the auxiliary service providers 18 by sending monthly capitation payments to the auxiliary service providers in exchange for the auxiliary service providers' promises to provide medical services to the patients 14 in the future in the form of medical RVUs in step 104.

The auxiliary service providers 18 may then contract with the primary service providers 12 by sending payments to the primary service providers 12 in exchange for the primary service providers' promises to provide a defined number of medical RVUs to the patients 14 in the future in step 106. In an exemplary embodiment, the defined number of medical RVUs that the primary service providers 12 agree to provide to the patients covered by the auxiliary service providers 12 may be, for example, well in excess of the monthly medical RVU capacity of the primary service providers.

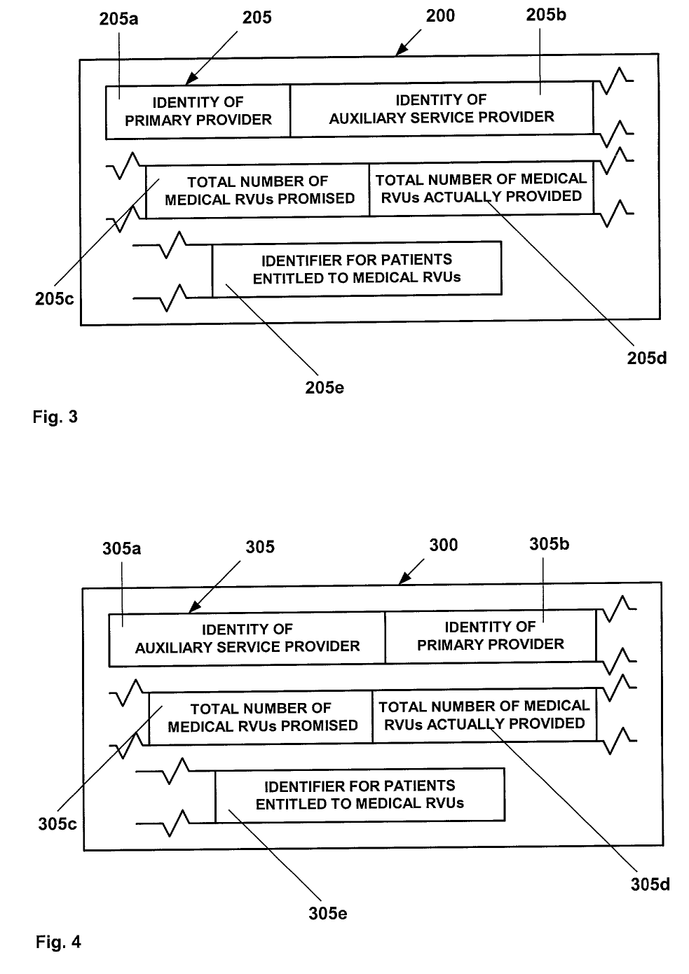

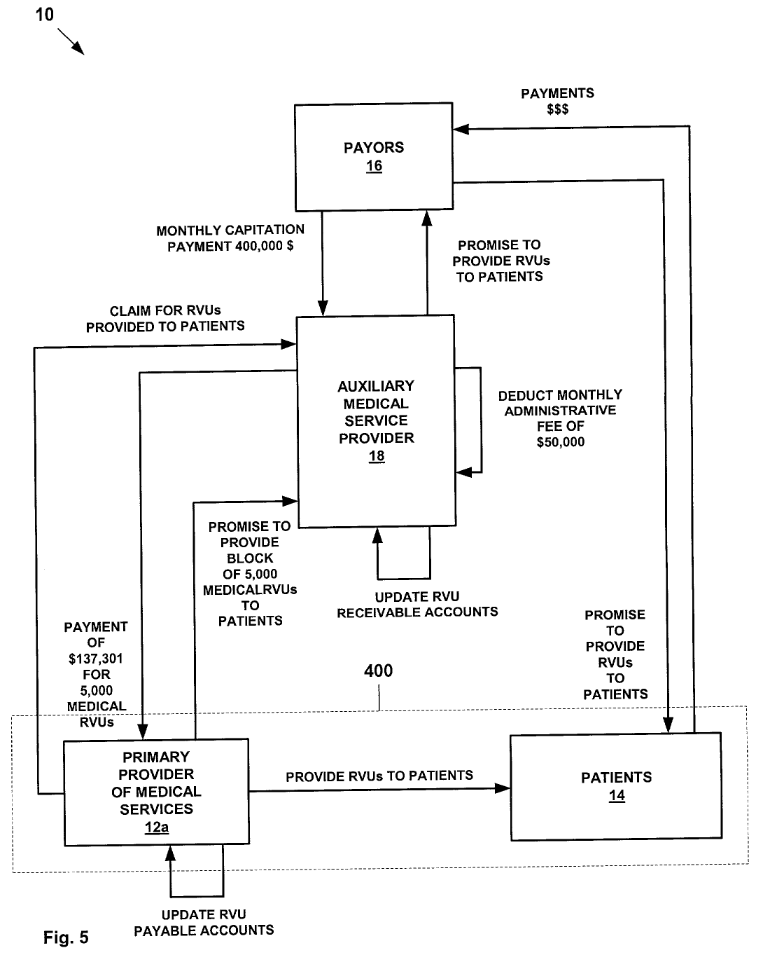

The auxiliary service providers 18 and the primary service providers 12 may then create corresponding medical RVU accounts receivable and payable, respectively, that may be maintained by the corresponding auxiliary service providers and the primary service providers, respectively, in step 108. As illustrated in FIG. 3, in an exemplary embodiment, a medical RVU accounts payable 200 may include one or more records 205 that include the identity of the primary service provider 205a, the identity of the auxiliary service provider that contracted with the primary service provider 205b, the total number of medical RVUs promised by the primary service provider 205c, the total number of RVUs actually provided to date by the primary service provider 205d, and a unique identifier that is representative of a group of one or more patients 14 that are entitled to receive the contracted for block of RVUs from the primary service provider 205e. As illustrated in FIG. 4, in an exemplary embodiment, a medical RVU accounts receivable 300 may include one or more records 305 that include the identity of the auxiliary service provider 305a, the identity of the primary service provider that contracted with the auxiliary service provider 305b, the total number of medical RVUs promised by the primary service provider 305c, the total number of RVUs actually provided to date by the primary service provider 305d, and a unique identifier that is representative of a group of one or more patients 14 that are entitled to receive the contracted for block of RVUs from the primary service provider 305e. In several alternative embodiments, the records, 205 and 305, of the medical RVU accounts payable and receivable, 200 and 300, respectively, may also include an indication of the contracted for value of each medical RVU.

If medical services in the form of medical RVUs are provided to the patients 14 by the primary service providers 12 in step 110, then the primary service providers may then submit claims to the corresponding auxiliary service providers 18 for the medical services provided in step 112. The primary service providers 12 that provided medical services in the form of medical RVUs to the patients 14 may then update the corresponding accounts payable records to reflect that the number of medical RVUs provided to date has increased by the corresponding amount in step 114, and the auxiliary service providers 18 to whom claims were submitted for medical services provided in the form of medical RVUs to the patients 14 may then update the corresponding accounts receivable records to reflect that the number of medical RVUs provided to date has increased by the corresponding amount in step 116.

Thus the present system 10 solves the problems of timing and predictability of cash flow to the primary service providers 12 by providing a system in which the auxiliary service providers 12 contract for blocks of medical RVUs in advance of their being provided to the patients 14. In this manner, the auxiliary service providers 12 may purchase the blocks of medical RVUs at a discounted rate thereby reducing the cost of providing medical RVUs to the patients 14. Furthermore, the primary service providers 12 are thereby paid in advance for the delivery of blocks of medical RVUs, instead of after the fact, thereby providing the primary service providers with predictability of cash flow as well as more efficient and predictable capacity utilization.

Furthermore, when an auxiliary service provider 18 contracts with a payor 16 to satisfy at least a portion of the medical service needs of the patients 14 covered by the payor 16, the auxiliary service provider effectively establishes a short position in medical RVUs. In particular, the auxiliary service provider 12 commits to sell medical services to the payor 16 that the auxiliary service provider does not yet have a contractual right to receive. In order to cover the short position of the auxiliary service provider 18 in medical RVUs, the auxiliary service provider 12 then enters the health care marketplace, i.e. the primary service providers 12, and buys medical RVUs from the hospitals and other primary service providers, paying at or below the then-prevailing market price for the medical RVUs. By purchasing for cash in advance a large block of medical RVUs, the auxiliary service provider 18 will take a long position in the medical RVUs of the primary service providers of services, and, by paying cash in advance, be able to secure those medical RVUs at a much more favorable price.

Referring to FIG. 5, in an exemplary implementation of the system 10, a payor 16 contracts with an auxiliary service provider 18 to provide medical RVUs to a group of patients 14 in a geographic region 400 and provides the auxiliary service provider 18 with a monthly capitation payment of $400,000. The auxiliary service provider then deducts an administrative fee of $50,000 resulting in a monthly capitation pool of $350,000.

In the exemplary embodiment, the primary service providers 12 in the geographic region 400 have an available monthly capacity of 11,000 medical RVUs. Included among the primary service providers 12 in the geographic region is a primary service provider 12a that provides, for example, diagnostic imaging procedures, in the amount of 750 medical RVUs per month. Consequently, the market value of a medical RVU in the defined geographic region would be $350,000 divided by 11,000 RVUs or $31.81 which equates to 86.91% of the Medicare Allowable. Furthermore, the primary service provider 12a of 750 RVUs per month of diagnostic imaging procedures could receive up to $31.81 per medical RVU or $23,857 per month for medical services rendered.

In the exemplary embodiment, the auxiliary service provider 18 may then contract with the primary service provider 12a of diagnostic imaging procedures whereby the primary service provider will provide a block of 5,000 medical RVUs to the patients 14 covered by the auxiliary service provider 18 in the geographic region 400 in exchange for a lump sum payment of $137,301. This equates to a medical RVU value of $27.46 which is 75% of the Medicare Allowable. Thus, the present system permits the auxiliary service provider 18 to obtain medical RVUs for delivery to the covered patients 14 at a cost that is below the prevailing market value.

In order to make the lump sum payment to the primary service provider 12a, the auxiliary service provider 18 may, for example, use cash reserves, a revolving credit facility, or other equity or debt instrument sources of cash. The primary service provider 12a will execute a promissory note, payable in medical RVUs to the auxiliary service provider 18, the value of which will equate to the total contracted dollar amount of $137,301. The auxiliary service provider 18 may then use the promissory note as collateral to borrow funds to finance the continued operation of the auxiliary service provider.

From an accounting standpoint, the auxiliary service provider 18 establishes an account receivable in the name of the primary service provider 12a and the primary service provider establishes an account payable in the name of the auxiliary service provider. These accounts will be credited, initially, with 5,000 medical RVUs. Each month, the account is charged, or reduced by, the medical RVUs consumed by the patients 14 who obtain covered services from the primary service provider 12a. For example, if the primary service provider 12a has delivered medical services totaling 842 medical RVUs to the patients 14 covered by the contract by the end of the first month of the contract. A balance of 4,158 medical RVUs will remain in the account receivable of the auxiliary service provider 18. The 842 medical RVUs times $27.46, or $23,121, will come out of the medical service inventory of the auxiliary service provider 18 at cost and will be charged appropriately in the accounting system of the auxiliary service provider to, for example, medical expense.

Furthermore, in the exemplary implementation of the system 10, from the standpoint of the auxiliary service provider 18, the sales price of the medical RVUs provided by the primary service provider 12a to the patients 14 during the first month of the contract between the auxiliary service provider and the payor 16 is equal to $31.82 times 842 medical RVUs or $26,792 and the cost of sales for the medical RVUs provided by the primary service provider 12a during the first month of the contract between auxiliary service provider and the primary service provider is equal to $27.46 times 842 medical RVUs or $23,121. The difference between the sales price and the cost of sales of $3,671 may be credited to medical expense and would represent a further reduction in the cost of sales for the auxiliary service provider 18. In effect, the auxiliary service provider 18 has reduced the cost of sales from $26,792, the amount that would occur in a conventional system, to $23,121-$3,671 or $19,450.

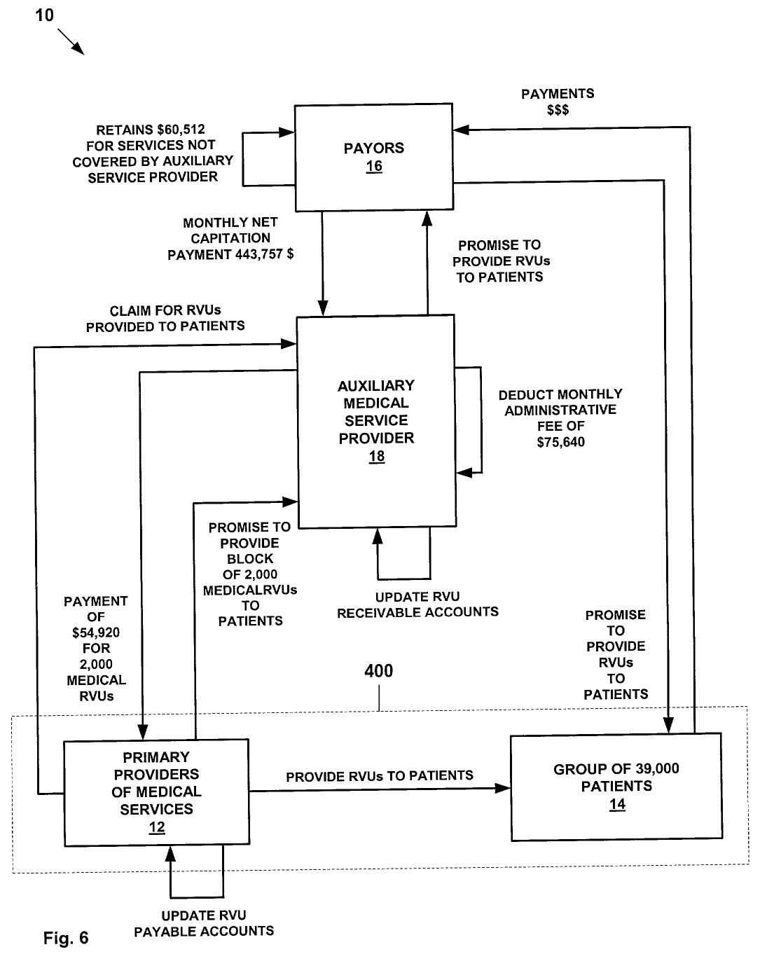

Referring to FIG. 6, in another exemplary implementation of the system 10, a payor 16, an insurance company, has 39,000 covered patients 14 in a geographical area 400. An auxiliary service provider 18 covers two lines of business for the payor 16 under a contract: Commercial and Medicare. Under the terms of the contract, the payor 16 pays the auxiliary service provider 18 a PMPM fee equal to $6.75 for Commercial patient members medical services and $15.65 for Medicare members medical services. The weighted average PMPM charge that the auxiliary service provider 18 receives from the payor 16 varies by month, depending upon the changing mix of the patient membership, but averages about $12.93.

Accordingly, the payor 16 owes to the auxiliary service provider 18 on a monthly basis 39,000×$12.93, or $504,270. For this amount, the auxiliary service provider 18 is responsible for providing designated outpatient radiology services to all 39,000 covered member patients 14 for the month. Recognizing that some patient members may go to facilities which are not participating in the network managed by the auxiliary service provider 18, the payor 16 withholds 12% of this amount to cover out-of-network payments that it must make directly to these other service providers. Accordingly, the payor 16 sends a monthly check to the auxiliary service provider 18 for 88% of $504,270, or $443,757.60. From this amount, the auxiliary service provider 18 deducts its administrative services fee of 15% of the $504,270, or $75,640.50. The balance remaining of $443,757.60 minus $75,640.50, or $368,117.10 is the amount of the capitation pool which is the amount that gets paid out to the radiology providers 12.

During the course of the month, the patients 14 will go to the contracted primary service providers 12 for services. The primary service providers 12 provide the medical services and send the auxiliary service provider 18 notification, in the form of a claim, describing the service provided. If the medical services provided are not covered, the claim is forwarded to the payor 16 for payment directly to the provider 12. If the medical services provided are covered, the medical RVU value for the provided medical service is added to the primary service provider's total for the month. At the end of the month, all medical RVUs for all covered medical services provided to covered member patients 14 during the month are totaled on a per primary service provider basis.

In an exemplary embodiment, the total number of medical RVUs provided on a monthly basis ranges from approximately 10,000-12,000 medical RVUs. By dividing the capitation pool amount, $368,117.10, by the medical RVUs in the pool, which may be, for example, 10,100, an RVU Fee Amount can be calculated. In this example, the medical RVU Fee Amount will be $36.8117, or 100.54% of the Medicare allowable. If the total medical RVUs provided in a month were 11,000, the RVU Fee Amount would be $33.4652, or 91.40% of the Medicare allowable. If the total medical RVUs provided in a month were 12,000, the RVU Fee Amount would be $30.6764, or 83.78% of the Medicare allowable.

The numerator in the RVU Fee Amount, which is the capitation pool, is somewhat fixed by the contractual relationship between the payor 16 and the auxiliary service provider 18 and fluctuates only with: (1) monthly changes in the number of patients 14 covered by the payor 16; and (2) the mix of patients covered by the payor's lines of business (e.g., Commercial or Medicare). The denominator in the RVU Fee Amount, which is the total number of medical RVUs, fluctuates with the number of medical procedures done on a monthly basis and the medical RVU values of those medical procedures. Using the previous example, if the payor 16 or the auxiliary service provider 18 has contracted with the primary service provider 12 to purchase medical RVUs at 75% of the Medicare allowable, or $27.4603, the primary service provider 12 performs services with an aggregate value of 2,000 medical RVUs and there are a total of 11,000 RVUs delivered in the pool, the payor 16 or the auxiliary service provider 18 benefits economically by 2,000 times ($33.4652-$27.4603), or $12,009.80. Similarly, the primary service provider 12 benefits economically because the primary service provider has been paid cash in advance equal to 2,000 times $27.4603, or $54,920.60 and has been able to utilize these funds to operate the primary service provider's business and/or reduce the primary service provider's debt levels without waiting 120 or more days to be paid.

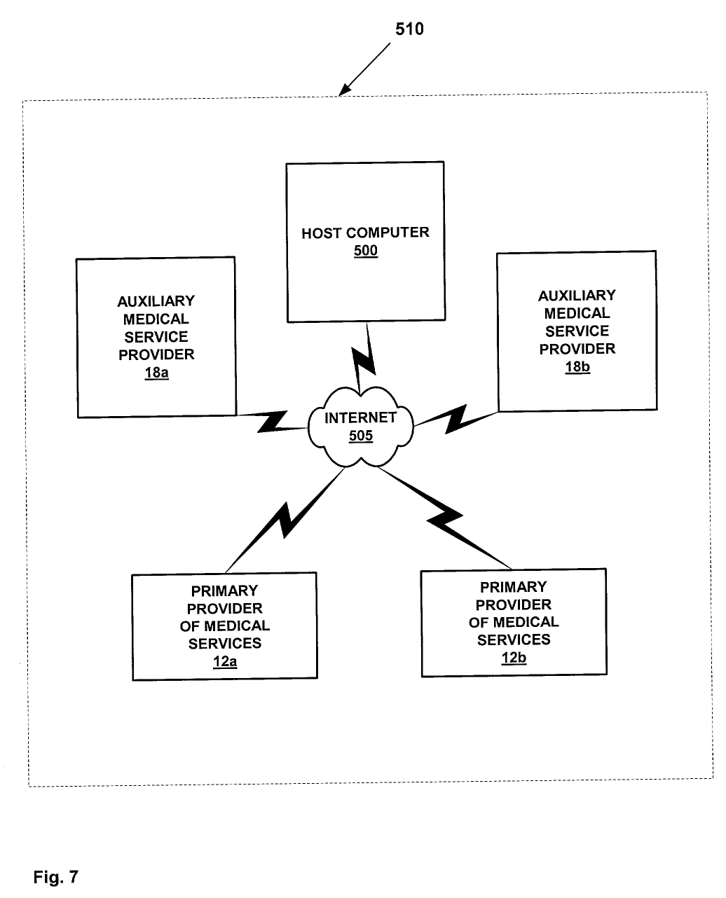

Referring to FIG. 7, in an alternative embodiment, the system 10 further includes a host computer 500 that is operably coupled to auxiliary service providers, 18a and 18b, and primary service providers 12a and 12b, by the Internet 505 in a conventional manner. During operation, the host computer 500 provides an online electronic trading system 510 whereby the auxiliary service providers 18 may place bids to purchase blocks of medical RVUs and the primary service providers 12 may offer blocks of medical RVUs for sale. The auxiliary service providers 12 and the primary service providers 18 may thereby negotiate and contract with one another. In several alternative embodiments, the online electronic trading system 510 may be implemented using the teachings of one or more of the following U.S. Pat. Nos.: 4,412,287, 4,674,044, 4,677,522, 4,799,156, 4,903,201, 5,077,665, 5,136,501, 5,664,115, 5,715,402, 5,717,989, 5,732,400, 5,794,219, 5,845,266, 5,873,071, 5,905,974, 5,905,975, 5,924,082, 5,974,403, 6,098,051, the disclosures of which are incorporated herein by reference. By utilizing the trading system 510, the purchase of blocks of medical RVUs by the auxiliary service providers 18 may be more cost effectively provided thereby further reducing the cost of providing medical services to the patients 14.

In an alternative embodiment of the system 10, in step 104, the payors 16 contract with the auxiliary service providers 18 to provide medical services to the patients 14 in the form of medical RVUs in return for fee-for-service payments by the payors to the auxiliary service providers. In this manner, the payors pay monthly fees to the auxiliary service provider as a function of the value of medical RVUs actually provided to the patients 14 during the corresponding month. Thus, the system 10 may be implemented in a capitation or fee-for-service operating environment.

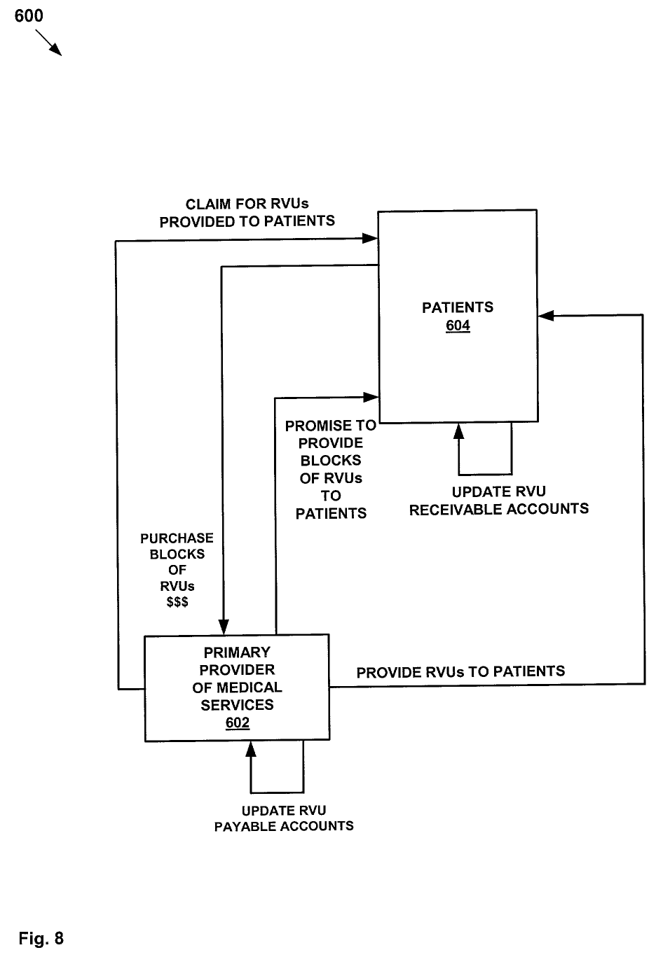

Referring to FIG. 8, an alternative embodiment of a system 600 for providing medical services includes one or more primary service providers of medical services 602 and one or more patients 604. The primary service provider of medical services 604 may, for example, include physicians, hospitals, skilled nursing facilities, outpatient diagnostic or surgical facilities or any other party who delivers medical care to patients.

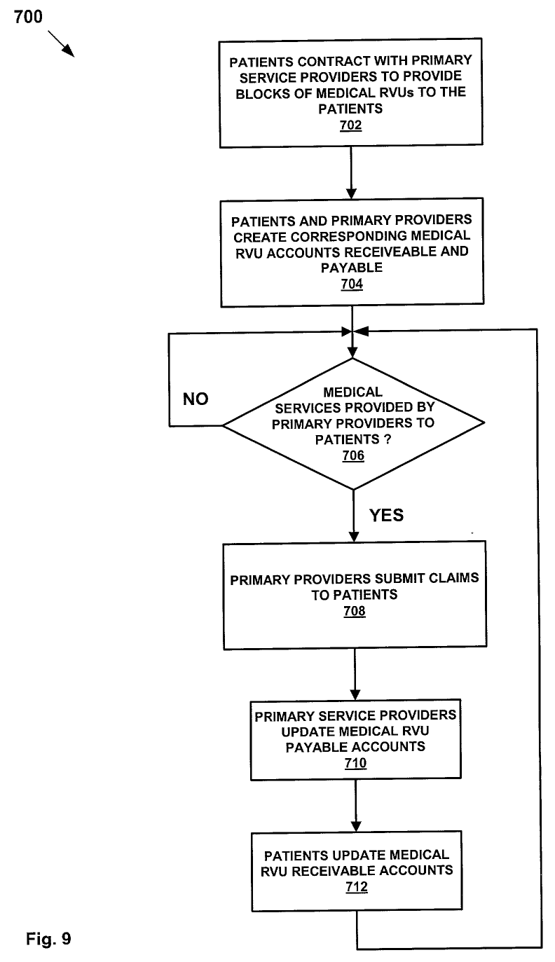

In an exemplary embodiment, during the operation of the system 600, as illustrated in FIGS. 8 and 9, the system 600 may implement a method 700 of providing medical services in which the patients 604 may contract with the primary service providers 602 by sending a lump sum payment to the primary service providers in return for the primary service providers' promises to provide the patients with medical services in the form of medical RVUs in the future in step 702.

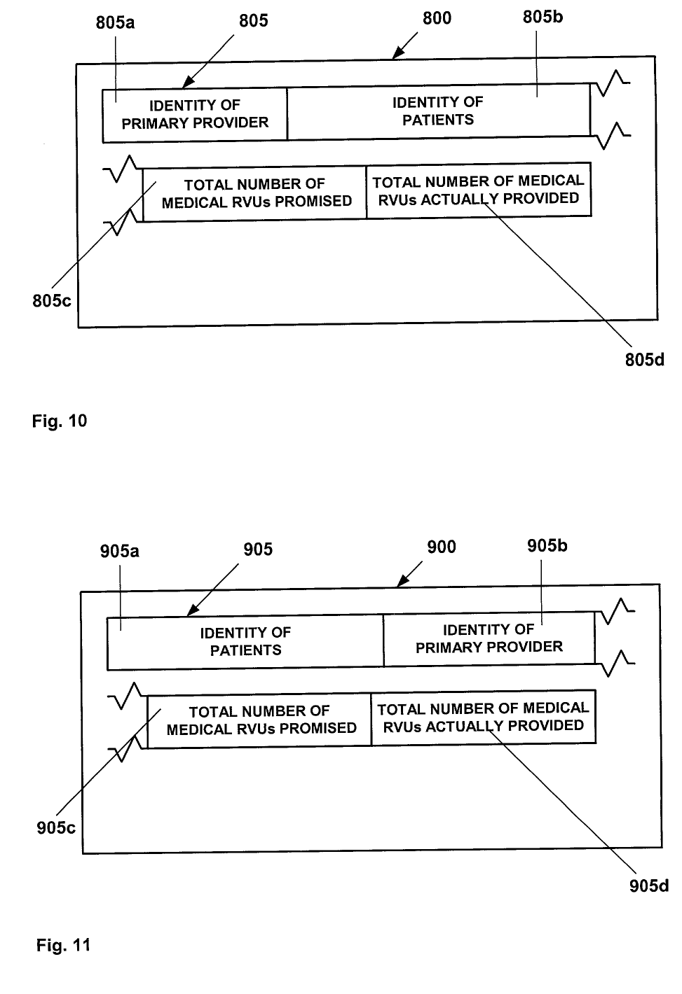

The patients 604 and the primary service providers 602 may then create corresponding medical RVU accounts receivable and payable, respectively, that may be maintained by the corresponding patients and the primary service providers, respectively, in step 704. As illustrated in FIG. 10, in an exemplary embodiment, a medical RVU accounts payable 800 may include one or more records 805 that include the identity of the primary service provider 805a, the identity of the patients that contracted with the primary service provider 805b, the total number of medical RVUs promised by the primary service provider 805c, and the total number of RVUs actually provided to date by the primary service provider 805d. As illustrated in FIG. 11, in an exemplary embodiment, a medical RVU accounts receivable 900 may include one or more records 905 that include the identity of the patients 905a, the identity of the primary service provider that contracted with the patients 905b, the total number of medical RVUs promised by the primary service provider 905c, and the total number of RVUs actually provided to date by the primary service provider 905d. In several alternative embodiments, the records, 805 and 905, of the medical RVU accounts payable and receivable, 800 and 900, respectively, may also include an indication of the contracted for value of each medical RVU.

If medical services in the form of medical RVUs are provided to the patients 604 by the primary service providers 602 in step 706, then the primary service providers may then submit claims to the corresponding patients for the medical services provided in step 708. The primary service providers 602 that provided medical services in the form of medical RVUs to the patients 604 may then update the corresponding accounts payable records to reflect that the number of medical RVUs provided to date has increased by the corresponding amount in step 710, and the patients 604 to whom claims were submitted for medical services provided in the form of medical RVUs to the patients may then update the corresponding accounts receivable records to reflect that the number of medical RVUs to be provided has decreased.

In an exemplary implementation of the system 600, the primary service providers 602 issue bonds, payable in medical RVUs, that are purchased by the patients 604.

It is understood that variations may be made in the foregoing without departing from the scope of the invention. For example, the patients, the payors, or the auxiliary service providers may contract with the primary service providers to provide blocks of medical RVUs to the patients. In this manner, the present embodiments may include one or more layers of intermediate parties between the patients and the primary service provider in order to distribute the management responsibility of providing medical services to the patients. Furthermore, the promissory notes may be further bought and sold and bundled as tradeable financial instruments in analogous fashion to home mortgages.

Although illustrative embodiments of the invention have been shown and described, a wide range of modification, changes and substitution is contemplated in the foregoing disclosure. In some instances, some features of the present invention may be employed without a corresponding use of the other features. Accordingly, it is appropriate that the appended claims be construed broadly and in a manner consistent with the scope of the invention.

What is claimed is:

1. A method of financing payments to providers of medical services to patients, comprising:
the patients making payments to a payor in exchange for the payor's promise to provide medical RVUs to the patients;
the payor making payments to an auxiliary service provider in exchange for the auxiliary service provider's promise to provide medical RVUs to the patients; and
the auxiliary service provider making a payment to a primary service provider in exchange for the primary service provider's promise to provide a block of medical RVUs to the patients.

2. The method of claim 1, further comprising:
the auxiliary service provider maintaining an account receivable that is representative of the degree to which the primary service provider has provided the block of medical RVUs to the patients.

3. The method of claim 1, further comprising:
the primary service provider maintaining an account payable that is representative of the degree to which the primary service provider has provided the block of medical RVUs to the patients.

4. The method of claim 1, further comprising:
the auxiliary service provider maintaining an account receivable that is representative of the degree to which the primary service provider has provided the block of medical RVUs to the patients; and
the primary service provider maintaining an account payable that is representative of the degree to which the primary service provider has provided the block of medical RVUs to the patients.

5. The method of claim 1, wherein the payments from the payor to the auxiliary service provider comprise capitation payments.

6. The method of claim 1, wherein the payments from the payor to the auxiliary service provide comprise fee for service payments.

7. A method of financing payments to providers of medical services to patients, comprising:
the patients making payments to one or more payors in exchange for the payors' promises to provide medical RVUs to the patients;
the payors making payments to one or more auxiliary service providers in exchange for the auxiliary service providers' promises to provide medical RVUs to the patients;
the auxiliary service providers bidding on blocks of medical RVUs offered for sale by one or more primary service providers in a medical RVU trading system; and
the auxiliary service providers contracting with one or more of the primary service providers using the medical RVU trading system.

8. The method of claim 7, further comprising:
the auxiliary service provider maintaining an account receivable that is representative of the degree to which the primary service provider has provided the contracted for block of medical RVUs to the patients.

9. The method of claim 7, further comprising:
the primary service provider maintaining an account payable that is representative of the degree to which the primary service provider has provided the contracted for block of medical RVUs to the patients.

10. The method of claim 7, further comprising:
the auxiliary service provider maintaining an account receivable that is representative of the degree to which the primary service provider has provided the contracted for block of medical RVUs to the patients; and
the primary service provider maintaining an account payable that is representative of the degree to which the primary service provider has provided the contracted for block of medical RVUs to the patients.

11. The method of claim 7, wherein the payments from the payor to the auxiliary service provider comprise capitation payments.

12. The method of claim 7, wherein the payments from the payor to the auxiliary service provide comprise fee for service payments.

13. A method of financing payments to providers of medical services to patients, comprising:
the patients making a payment to a primary service provider in exchange for the primary service provider's promise to provide a block of medical RVUs to the patients.

14. The method of claim 13, further comprising:
the patients maintaining an account receivable that is representative of the degree to which the primary service provider has provided the block of medical RVUs to the patients.

15. The method of claim 13, further comprising:
the primary service provider maintaining an account payable that is representative of the degree to which the primary service provider has provided the block of medical RVUs to the patients.

16. The method of claim 13, further comprising:
the patients maintaining an account receivable that is representative of the degree to which the primary service provider has provided the block of medical RVUs to the patients; and
the primary service provider maintaining an account payable that is representative of the degree to which the primary service provider has provided the block of medical RVUs to the patients.

17. The method of claim 13, further comprising:
the primary service provider issuing bonds payable in blocks of medical RVUs; and
the patients purchasing the bonds.

18. A method of financing payments to providers of medical services to patients, comprising:
the patients bidding on blocks of medical RVUs offered for sale by one or more primary service providers in a medical RVU trading system; and
the patients contracting with one or more of the primary service providers using the medical RVU trading system.

19. The method of claim 18, further comprising:
the patients maintaining an account receivable that is representative of the degree to which the primary service provider has provided the block of medical RVUs to the patients.

20. The method of claim 18, further comprising:
the primary service provider maintaining an account payable that is representative of the degree to which the primary service provider has provided the block of medical RVUs to the patients.

21. The method of claim 18, further comprising:
the patients maintaining an account receivable that is representative of the degree to which the primary service provider has provided the block of medical RVUs to the patients; and
the primary service provider maintaining an account payable that is representative of the degree to which the primary service provider has provided the block of medical RVUs to the patients
